(19) United States
(12) Patent Application Publication
(10) Pub. No.: US 2009/0125999 A1
(43) Pub. Date: May 14, 2009

(54) User Authorization Technique

(76) Inventor: Marcelo A. Calbucci, Redmond, VA (US)

Correspondence Address: John Whitaker;Whitaker Law Group, 755 WINSLOW WAY EAST, Suite 100, BAINBRIDGE ISLAND, WA, 98110, US

(21) Appl. No.: 12/177,074

(22) Filed: Jul. 21, 2008

Related U.S. Application Data
(60) Provisional application No. 60/961,062, filed on Jul. 19, 2007.
(60) Provisional application No. 60/961,061, filed on Jul. 19, 2007.

(51) Int. Cl. H04L 9/32; G06F 21/00

(52) U.S. Cl. 726/7

(57) ABSTRACT

Described are a system and method for invisible authorization of a visitor to a web site. A system uses a specially formed URL that provides visitors access to secure content without requiring a sign-in and/or sign-up step, yet, if the URL is forwarded to others the content is not accessible. The URL can be delivered in an electronic message.

### REFERENCE TO RELATED APPLICATIONS

This application claims priority to co-pending U.S. Provisional Patent Application Nos. 60/961,062 entitled System and Method to Authenticate, Authorize and Serve Images On Private Email Messages and 60/961,061 entitled System and Method to Authenticate and Authorize Private Links Through Email Messages, both filed Jul. 19, 2007 and both of which are hereby incorporated by reference for all purposes.

### TECHNICAL FIELD

The invention relates to the area of computing networks, and more particularly to the area of network authentication.

### BACKGROUND

Information is shared online with increasing frequency. For instance, so-called “social networks” have exploded in popularity over recent years. Social networks allow users to create their own personalized site or “space” online for others to see. On these personalized sites, the users publish personal information and frequently include pictures of themselves or their loved ones. Social networks are a great way for people to keep in touch with family, friends, or colleagues, and to meet new people.

However, for all their benefits, social networks are not without their drawbacks. Many people are concerned about their privacy and resist the urge to share their personal information online. While many people do share information about themselves online, very many more are reluctant to do so because of the risk that their information would fall into the wrong hands or be used in some unintended and nefarious way. For instance, the pictures that users upload to their personalized sites may be copied by others and used in unauthorized and even offensive ways. People fear that malevolent stalkers could use the publicized information to find them and perhaps do them harm.

Mechanisms exist that seek to reduce or even eliminate the risks associated with publishing personal information online. The most common, and perhaps most effective method is to disallow the general public from viewing one's social network site unless personally invited. With this system, the site owner authorizes someone else to visit the owner's site, generally by invitation. However, these invitations require the invitee to create their own account with the social network and then log in with the service in order to view the owner's site. While it may seem a small task, the need to create a new account and remember new login credentials is enough of a burden to put many people off.

Another mechanism to protect personal content is to keep the location of the personal content secret, and only share a link to that content with authorized individuals. However, this mechanism suffers from the shortcoming that there is nothing to prevent those authorized individuals from sharing the private link with other, unauthorized individuals.

Although described here in the context of social networking, many other online services also suffer from the same drawbacks as just described. For example, services exist that allow online access to documents or electronic messages, rather than personal information, to be granted by site owners. The hurdle created by requiring login credentials for visitors is a pervasive problem that afflicts many different online services.

An adequate solution to these difficult problems has proven elusive to those skilled in the art, until now.

### SUMMARY

The invention is generally directed at a system and method for authorization of a visitor to a web site. In one implementation, the system provides visitors to a web site with semi-automatic authorization, in which the user need not take any explicit steps to confirm the authorization. The system uses a specially formed URL that provides visitors access to secure content without requiring a sign-in and/or sign-up step, yet, if the URL is forwarded to others the content is not accessible. The URL can be delivered in an electronic message.

### BRIEF DESCRIPTION OF DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings. Moreover, in the drawings, like reference numerals designate corresponding parts throughout the several views.

FIG. 1 is a functional block diagram generally illustrating a network computing environment in which is implemented a system for authorizing a visitor to a Web site without using the traditional username/password combination, but while maintaining a high level of security.

FIG. 2 is a diagram of an illustrative URL constructed in accordance with one implementation of a system for invisible authorization of a visitor to a web site.

FIG. 3 is a functional block diagram of an authorization table that may be used in implementations of a system for invisible authorization of a visitor to a web site.

FIG. 4 is an operational flow diagram generally illustrating a process for authorizing a new visitor to access a site owner's secure pages.

FIG. 5 is an operational flow diagram generally illustrating a process for invisibly authorizing a visitor to secure pages of a web site.

### DETAILED DESCRIPTION OF PREFERRED EMBODIMENTS

The preferred embodiments of the present invention will now be described more fully with reference to the accompanying drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

Briefly stated, the following embodiments illustrate one preferred system that uses a specially formed URL to provide visitors access to secure content without requiring a sign-in and/or sign-up step, yet, if the URL is forwarded to others the content is not accessible. In one specific embodiment, the URL is delivered in an electronic message.

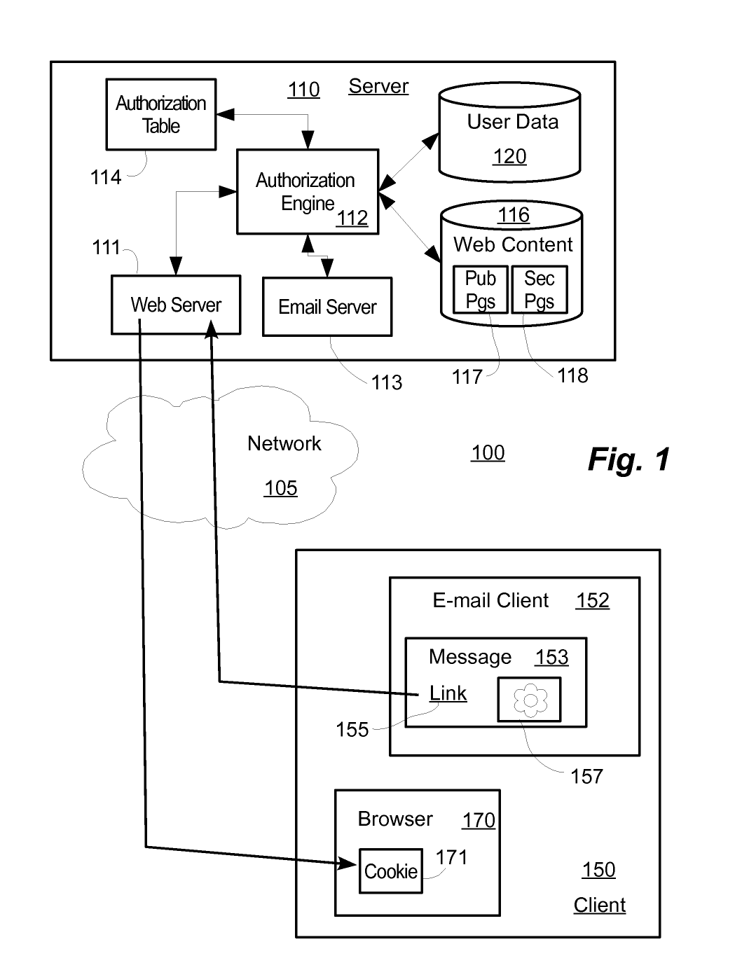

FIG. 1 is a functional block diagram generally illustrating a network computing environment 100 in which is implemented a system for authorizing a visitor to a Web site without using the traditional username/password combination, but while maintaining a high level of security.

As shown in FIG. 1, the network computing environment 100 includes a server 110 and one or more client computers 150. The server 110 is a computing device configured to serve information, such as Web content, over a wide area network 105, such as the Internet. The server 110 implements much of the typical functionality found in conventional devices, such as a Web server program 111 and an e-mail server program 113. The Web server program 111 is configured to make Web content 116 available to other devices that request it over the network 105. For the purpose of this discussion, Web content 116 includes any content that is deliverable over a network connection, such as Web pages, streaming audio or video, images, and the like. The e-mail server program 113 is configured to at least transmit electronic messages at the request of other components, such as the authorization engine 112. Web server programs and e-mail server programs are well known. The server 110 may be associated with an online service, such as, for example, a social networking site, or the like. The server 110 may alternatively be associated with any service that offers information over the network 105.

The Web content 116 being served may include both public content 117 and secure content 118. As suggested by their names, the public content 117 is accessible without regard to secure credentials, and the secure content 118 is only accessible to those visitors who are authorized. The public content 117 may include any information that the operator of the server deems appropriate for public access, such as general information pages, login or startup pages, access to public documents, and the like.

The secure content 118 includes information that the operator of the server deems inappropriate for public access, such as individual user pages, private documents, personal images, and the like. The secure content 118 is only accessible to certain users, such as the operator of the server 110, the owner of the secure pages 118, and those expressly authorized by the owner of the secure content 118, to name a few. There may be multiple divisions within the secure content, in which different subsets of the content are available to differently authorized users.

User data 120 includes information that identifies accounts and information about the account holders for users who make use of the services provided by the server 110. For example, if the server 110 were affiliated with a social networking online service, the user data 120 could include identifying information about the owners of the several personal sites served by the social network. The user data 120 would also identify any other users that the owner authorized to view the owner's site, which likely includes some secure content 118. The user data 120 may also include much additional information, such as billing information for the individual users and perhaps usage information collected about the users' browsing habits.

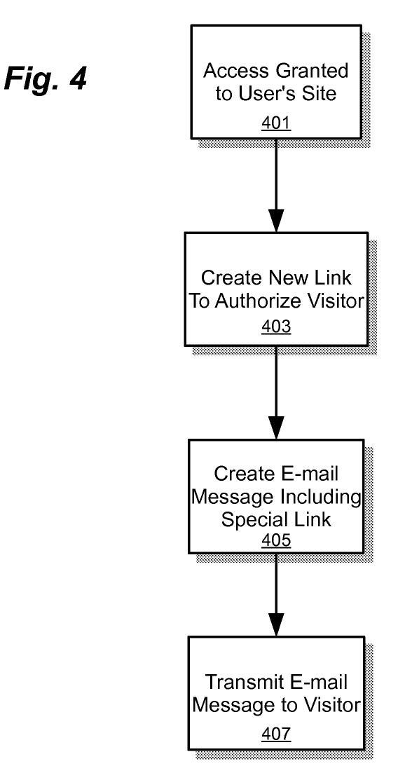

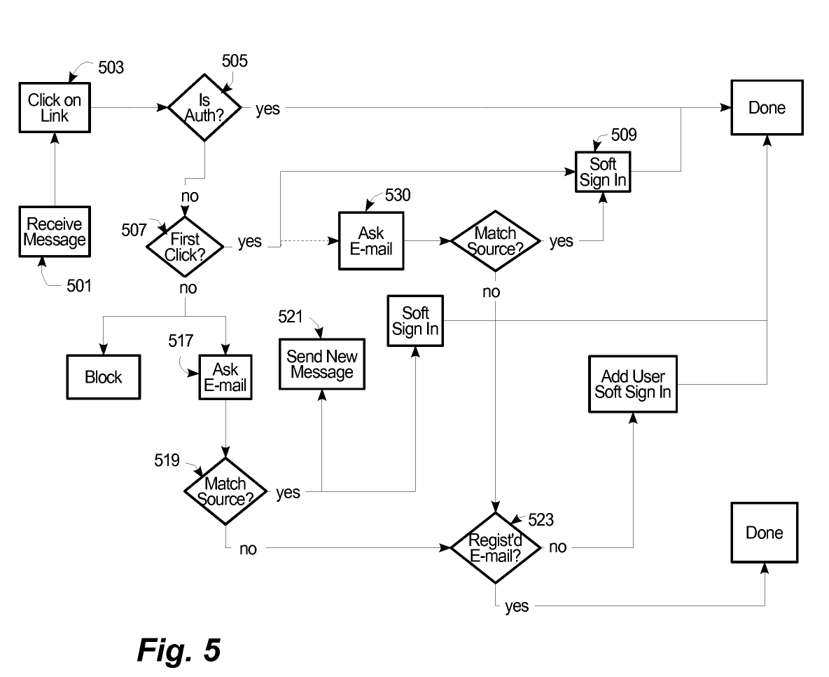

An authorization engine 112 is specially configured to evaluate requests for the secure content 118 to determine if a requesting visitor is authorized to view the requested secure page. The authorization engine 112, among other things, makes use of stored user data 120 and an authorization table 114 (described below) to determine whether to allow access to a requested secure page 118. It should be apparent that access to public content 117 generally does not require special authorization. Although introduced here, one illustrative process that may be implemented by the authorization engine 112 is described in detail below in conjunction with FIGS. 4-5.

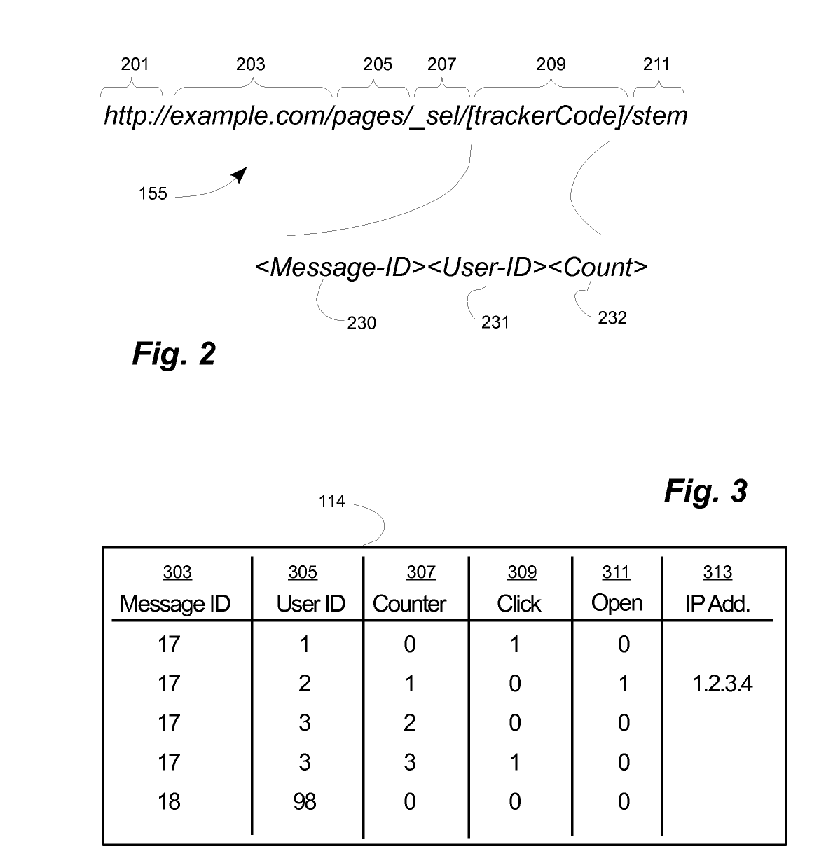

In one embodiment, the authorization engine 112 is further configured to construct an electronic message (e-mail message) in response to an invitation to view secure content 118. In addition, the authorization engine 112 includes logic to formulate a special code (an “authorization code”) that may be included in an e-mail message to authorize the recipient, and only the recipient, of the message to view secure content 118. In one specific implementation, the special code takes the form of a Uniform Resource Locator (URL) or may be embedded within a URL. One specific implementation of such a special URL is illustrated in FIG. 2, and described below.

The client computer 150 may be a general purpose computing device operative to connect to other computing devices, such as the server 110, over the network 105. In this implementation, the client computer 150 includes an e-mail client 152 and a browser 170. The e-mail client 152 is a software program used to communicate using electronic messages. The e-mail client 152 may be configured to communicate with other servers (not shown) using messaging protocols, such as POP3, IMAP, and SMTP, to exchange electronic messages with other users. In this particular implementation, the e-mail client 152 has received an e-mail message 153 from the server 110. The e-mail message 153 includes a link 155 and an image 157. The link 155 includes a special code that identifies the location of secure content 118 for which the recipient of the e-mail message 153 has been authorized. One particular implementation (among many) of the link 155 is illustrated in FIG. 2.

Turning briefly to FIG. 2, the link 155 may take any one of many forms, but in this example it is illustrated as a Uniform Resource Locator (URL) (also sometimes referred to as Uniform Resource Identifiers). The URL is composed of several elements, a protocol 201, a server ID 203, a path 205, a trigger code 207, an authorization code 209, and a resource ID 211.

The protocol 201 identifies the particular communication protocol to use to retrieve the identified resource. Examples of acceptable protocols include http, https, ftp, gopher, telnet, mailto, news, wais, and file. The server ID 203 identifies the domain at which the identified resource resides. The path 205 indicates the location of the identified resource within a folder structure at the identified domain. The resource ID 211 particularly identifies the resource, such as by name.

In this implementation, the trigger code 207 is a special code indicating that the link 155 includes an authorization code 209. The trigger code 207 is optional. The authorization code 209 may include a Message-Id 230 that uniquely identifies each message sent, a User-Id 231 if the message was sent to a registered user and an Item-Count 232 that is a counter of the number of messages sent, so even messages sent to the same email-id and user-id can be uniquely identified. Optionally, the entire authorization code 209 may be encrypted or signed to prevent malicious interference.

Returning to FIG. 1, the e-mail message 153 also includes an image 157. As is known in the art, e-mail messages that include images are frequently constructed by incorporating a special link to an image file that is stored in a publicly accessible location. When the e-mail client 152 renders the e-mail message 153, it retrieves the image from the publicly accessible location. In one alternative embodiment, the image 157 is identified for retrieval using a specially constructed image link, similar to link 155, that points to an image stored in the secure content 118.

The client 150 also includes browser software 170, which is a software program for retrieving and rendering network accessible resources. The browser 170 includes a rendering engine (not shown) operative to interpret markup language documents and display the interpreted content. The browser 170 is also configured to store and transmit persistent data, such as so-called “cookies” 171, which are small text files that include information that is transmitted to a domain in conjunction with a request (e.g., an HTTP GET request) for a resource resident at that domain. Cookies are well known in the art.

The e-mail client 152 is illustrated as a separate component from the browser 170 in this implementation, although it should be appreciated that in other implementations the e-mail client 152 and the browser 170 could be the same component. For instance, the browser 170 could be used to access an e-mail account over the network 105 and view messages stored on a remote server (commonly referred to as “webmail”).

The operation of the system 100 illustrated in FIG. 1 and described above will now be described in the following operational flow diagrams, with reference to the various functional block diagrams illustrated above. It should be noted that the operations described below may be performed with many different implementations other than those described above. The operations are described with reference to the functional block diagrams for simplicity of discussion only, and in no way are the operations strictly bound to the elements described above.

FIGS. 4 and 5 are operational flow diagrams generally illustrating one illustrative process for performing an invisible authorization of a visitor to a web site. The process may be implemented using the components of the system illustrated in FIG. 1 and described above. However, the operations of the process may be performed by many hardware and software implementations other than those described above. Reference to the system described above is merely for simplicity of discussion and to provide some concrete foundation for the abstract concepts implemented by the process. Reference here to the system described above is not in any way indicative of an inextricable union of the following process to the above system.

Turning first to FIG. 4, an authorized user of the server 110 maintains a personal site that includes secure content 118, and may include public content 117 as well. The user grants access to the user's personal site (e.g, secure content 118 associated with the user) to another individual (“visitor”), such as by inviting the visitor to view the site (step 401). In this implementation, the user identifies the visitor by an e-mail address. In response, the authorization engine 112 creates a special URL to provide the visitor with access to the authorized secure pages (step 403). The special URL includes a Message ID that uniquely identifies the invitation and the visitor that will be authorized by it.

The authorization engine 112 also creates an e-mail message addresses to the visitor's e-mail address (step 405). The special URL is included as a link 155 in the e-mail message, and the message 153 is transmitted to the visitor (step 407) via the client computing device 150.

Turning now to FIG. 5, the visitor receives the e-mail message 153 (step 501) and clicks the link 155 in the message 153 (step 503), thus activating the URL. Upon clicking the link 155, the browser 170 opens the URL and attempts to retrieve the identified resource 211 from the domain 203. In this case, the domain 203 points to the web server program 111 executing on the server 110. Thus, the browser 170 issues a request to the web server program 111 to retrieve the resource (secure page 118) pointed to by the special URL 155.

At the server, the web server program 111 passes the request off to the authorization engine 112, which performs a set of tests and checks to authenticate and authorize the visitor making the request. First, the authentication engine 112 determines if the request is already authorized by determining if the request included an authorization cookie (step 505). If not, then the request is not authorized. If the request includes an authorization cookie, then the request is authorized without further input from the visitor and without

However, if the request did not include the authorization cookie, the authorization engine 112 detects the authorization code 209, decrypts it (if necessary), decodes it, verifies its integrity, and checks if the authorization code 209 has been accessed (step 507). The authorization engine 112 determines if this is the “first click”, meaning that at no time prior has a request been received from a browser using that exact URL 155, by referencing the authorization table 114.

Turning briefly to FIG. 4, the authorization table 114 includes several records, one for every instance of a special link 155 sent out by the server 110. Each record includes a field that corresponds to the fields of the authorization code 209, namely a message ID field 303, a user ID field 305, and a counter field 307. In addition, each record further includes a clicked field 309, and may optionally include an open field 311 and an IP address field 313. Each record is created when the link 155 is created, and the clicked field 311 is initialized to zero, indicating that the link has not been clicked. In another embodiment, the open field 311 is initialized to zero to indicate that an image link has not been accessed.

Accordingly, the authorization engine 112 locates the record having the appropriate message ID 230 in the message ID field 303, and the appropriate count 232 in the counter field 307. Then, if the clicked field 309 for the identified record is still zero, this indicates that the link 155 has never been clicked, thus this is the “first click”.

Returning to FIG. 5, if this is the first click, the browser 170 is automatically redirected to the requested secure page 118 it requested, and an authorization cookie 171 is saved on the client computer 150 (step 509). In this manner, on subsequent clicks of the link 155, the authorization cookie 171 is included with the request, and the visitor will be automatically authorized (step 505). Thus, if the visitor is revisiting a site, the authorization engine 112 detects the saved cookie and bypasses the authorization code check, such that consecutive visits to the site are authorized without the need for the visitor to manually login.

However, if the clicked field 309 is non-zero, indicating that the link 155 has already been clicked, the authorization engine 112 detects that the authorization code 209 was already accessed from a different computer. For example, if the original recipient forwarded the email message 153 to a second visitor, and the second visitor tried to click the link 155, there would not be an authorization cookie 171 with the request and the clicked field 309 would be non-zero. In this case, the authorization engine 112 may challenge the access by prompting the new visitor for an authorized email address (step 517). If the e-mail address provided by the new visitor matches (step 519) the original e-mail address of the recipient of the message 153, a new message with a new authorization code 209 is sent (step 521). In this case, the counter is incremented in both the authorization code (count 232) and the counter field 307. If the e-mail address provided by the new visitor does not match the original e-mail address, the new visitor's access is rejected, and the new visitor is prompted to request authorization from the site owner (step 523).

Addressing now the issue of images, it will be appreciated that conventional e-mail clients are not capable of delivering a cookie with a request for a resource pointed to by a URL. Thus, if the e-mail message 153 includes an image 157 pointed to with a link of the type described above, the authorization engine 112 will be unable to store an authorization cookie on the client computer 150 that can be used by the e-mail client 152. Thus, to address this case, if a request for the image 157 is received by the authorization engine 112, it sets the open field 311 in the associated record for that link to indicate that the image has been retrieved from the server 110. In addition, the authorization engine 112 will store some form of identifying information (the requesting IP address in this implementation) in authorization table 114. If the IP address is used (IP address field 313), subsequent requests for the image originating either from the same IP address or from an IP address sufficiently similar to the same IP address will be authorized.

The system 100 may also provide a multiple configuration mechanism so site owners can balance security versus convenience for their users. The mechanism can be configured for less security, such as authorizing everybody (regardless of whether invited), but log their access (step 505). Alternatively, the mechanism can be configured for greater security, where new visitors are required to confirm their email address each time they click on a link on in email message (step 530).

The system 100 may also implement audit information for each message sent and for each request associated with a clicked link. This way it is possible to know if an e-mail message was accessed from a single computer and if it was forwarded to others. Moreover, the system 100 may be configured to transmit an authorization code to authorized users in conjunction with any communication with the users, not only in conjunction with invitations to authorize other users.

Process and function descriptions and blocks in flow charts can be understood as representing, in some embodiments, modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention. In addition, such functional elements can be implemented as logic embodied in hardware, software, firmware, or a combination thereof, among others. In some embodiments involving software implementations, such software comprises an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a computer-readable medium can be any means that can contain, store, communicate, propagate, or transport the software for use by or in connection with the instruction execution system, apparatus, or device.

The preceding description has been presented for purposes of illustration only, and is not intended to be exhaustive or to limit the claims to the embodiments disclosed. Many modifications and variations will be apparent to those of ordinary skill in the art. The embodiments were chosen and described in order to best explain the principles of the invention, the practical application, and to enable others of ordinary skill in the art to develop various embodiments with various modifications as are suited to the particular use contemplated.

What is claimed is:

1. A computer-readable medium encoded with computer-executable instructions for authorizing a visitor to a web site, the instructions comprising:
receiving a request to access a secure resource identified by a locator;
evaluating the locator to identify an authorization code within the locator that indicates the request is authorized to retrieve the resource;
determining if the authorization code has already been used to authorize the retrieval of the resource; and
if the authorization code has not already been used to authorize a prior request, allowing the access to the secure resource without first prompting for login credentials and transmitting persistent data to the requester for use in subsequent requests to access the secure resource.

2. The computer-readable medium recited in claim 1, wherein the locator comprises a Uniform Resource Locator and the persistent data comprises a cookie.

3. The computer-readable medium recited in claim 1, wherein the authorization code comprises a message ID and a counter, the message ID identifying a particular message, the counter identifying a particular instance of the particular message.

4. The computer-readable medium recited in claim 3, wherein the particular message comprises an e-mail message.

5. The computer-readable medium recited in claim 1, further comprising:
if the authorization code has already been used to authorize a prior request, rejecting the request.

6. The computer-readable medium recited in claim 5, wherein rejecting the request comprises prompting for a requester e-mail address, and comparing the e-mail address with information that associates the authorization code with an authorized e-mail address.

7. The computer-readable medium recited in claim 6, further comprising, if the requester e-mail address matches the authorized e-mail address, creating a new authorization code based on the authorized e-mail address and transmitting the new authorization code to the requester e-mail address.

8. The computer-readable medium recited in claim 1, wherein determining if the authorization code has already been used comprises evaluating an authorization table that includes records for each authorization code, each record including a field that contains a value to indicate whether the authorization code has been used.

9. The computer-readable medium recited in claim 1, wherein the secure resource comprises personal pages associated with a social networking service.

10. A computer-readable medium encoded with computer-executable components for authorizing a visitor to a web site, the components comprising:
an authorization engine to authorize requests for secure resources stored on a server, the authorization engine being configured to:
create a URL including an authorization code including a message ID and a counter, the message ID being uniquely associated with a particular message, the counter being associated with a particular instance of the particular message;
transmit an electronic message having a link to a secure resource, the link identifying a location of the secure resource and including the authorization code.

11. The computer-readable medium recited in claim 10, wherein the authorization engine is further configured to:
receive a request to access the secure resource at the location identified by the link, the request including the authorization code;
extract the authorization code from the request;
compare the authorization code to data stored in an authorization table, the data indicating whether the authorization code has been used in a prior request for access to the secure resource; and
if the authorization code has not been used to authorize a prior request, allow the access to the secure resource without first prompting for login credentials and transmit persistent data to the requester for use in subsequent requests to access the secure resource.

12. The computer-readable medium recited in claim 10, wherein the link comprises a Uniform Resource Locator and the persistent data comprises a cookie.

13. The computer-readable medium recited in claim 11, wherein the authorization engine is further configured to:
if the authorization code has already been used to authorize a prior request, reject the request.

14. The computer-readable medium recited in claim 13, wherein the authorization engine is further configured to reject the request by prompting for a requester e-mail address, and comparing the e-mail address with information that associates the authorization code with an authorized e-mail address.

15. The computer-readable medium recited in claim 14, wherein if the requester e-mail address matches the authorized e-mail address, the authorization engine is further configured to create a new authorization code based on the authorized e-mail address and to transmit the new authorization code to the requester e-mail address.

16. The computer-readable medium recited in claim 11, wherein the authorization engine is further configured to determine if the authorization code has already been used by evaluating an authorization table that includes records for each authorization code, each record including a field that contains a value to indicate whether the authorization code has been used.

17. The computer-readable medium recited in claim 11, wherein the secure resource comprises personal pages associated with a social networking service.

18. A method for authorizing a visitor to a web site, comprising:
receiving a request to access a secure resource identified by a locator;
evaluating the locator to identify an authorization code within the locator that indicates the request is authorized to retrieve the resource;
determining if the authorization code has already been used to authorize the retrieval of the resource; and
if the authorization code has not already been used to authorize a prior request:
storing an indication that the authorization code has been used in an authorization table,
storing an IP address associated with the request, and
allowing the access to the secure resource without first prompting for login credentials.

19. The method recited in claim 18, wherein determining if the authorization code has already been used to authorize the retrieval of the resource comprises comparing the IP address associated with the request with a stored IP address in an authorization table, the stored IP address being associated with a prior request to access the secure resource.

20. The method recited in claim 18, wherein the locator comprises a Uniform Resource Locator.
